(19) United States
(12) Patent Application Publication
(10) Pub. No.: US 2012/0116827 A1
(43) Pub. Date: May 10, 2012

(54) PLANT ANALYZING SYSTEM

(75) Inventor: Mitsutoshi Susumago, Musashino-shi (JP)

(73) Assignee: YOKOGAWA ELECTRIC CORPORATION, Tokyo (JP)

(21) Appl. No.: 13/289,623

(22) Filed: Nov. 4, 2011

(30) Foreign Application Priority Data
Nov. 5, 2010 (JP) 2010-248761

(51) Int. Cl. G06Q 10/00

(52) U.S. Cl. 705/7.11

(57) ABSTRACT

A plant analyzing system which can include an accepting section that accepts a definition of a soft-sensor for creating key information used for diagnosing the plant based on the data obtained from the plant; a storage section that stores the soft-sensor; a monitoring data generating section that generates the key information in real time as data for monitoring the plant based on the data obtained from the plant and using the stored soft-sensor; a monitoring data display section that displays in real time the data for monitoring the plant on a screen for monitoring an operation; a history data accumulating section that accumulates the data obtained from the plant as history data; and an analyzing data generating section that generates the key information, as data for analyzing a plant state of the past, based on the accumulated history data and using the stored soft-sensor.

### BACKGROUND

1. Technical Field

The present disclosure relates to a plant analyzing system for analyzing a state of a plant based on data obtained from the plant.

2. Related Art

For the stable and safe operation of a plant in a process manufacturing industry for producing, for example, food/beverage, chemical products, medicines, petroleum, and materials, those working in the plant manage the quality, delivery date and the like of a product by learning a process state based on various types of information collected from various sources.

Many workers with different tasks (e.g., production chief, operation staff, maintenance staff, and operator) are involved in the operation of a plant. The respective workers individually collect information using a different tool. The operator of the plant, for example, monitors trends of process data, which largely affects the quality of a product, according to a producing instruction of the day. Based on the trends, the production chief checks whether the amount of finished products will meet the planned volume of production. The production chief also checks the working conditions/schedules of those involved in the production. The operation staff checks trends of a processing state of each procedure in the production. The maintenance staff checks trends of an operating state of a facility.

Japanese Patent Application Laid-Open No. 2004-78812 describes a process data analyzing method for analyzing a process state based on process data.

### SUMMARY

A plant analyzing system analyzes a state of a plant based on data obtained from the plant, and includes: an accepting section that accepts a definition of a soft-sensor for creating key information used for diagnosing the plant based on the data obtained from the plant; a storage section that stores the soft-sensor defined through the accepting section; a monitoring data generating section that generates the key information in real time as data for monitoring the plant based on the data obtained from the plant and using the soft-sensor stored in the storage section; a monitoring data display section that displays in real time the data for monitoring the plant, generated by the monitoring data generating section, on a screen for monitoring an operation; a history data accumulating section that accumulates the data obtained from the plant as history data; and an analyzing data generating section that generates the key information, as data for analyzing a plant state of the past, based on the history data accumulated in the history data accumulating section and using the soft-sensor stored in the storage section.

### BRIEF DESCRIPTION OF DRAWINGS

The advantages of the invention will become apparent in the following description taken in conjunction with the drawings, wherein:

FIG. 1 is a block diagram illustrating a configuration of a plant analyzing system according to one embodiment;

FIG. 2A is a flowchart showing the flow of a productivity improving work, and

FIG. 2B is a flowchart showing the flow of a productivity maintaining work;

FIG. 3A is a diagram illustrating an exemplary configuration of a product unit, and FIG. 3B is a diagram illustrating an exemplary configuration of a procedure unit;

FIGS. 4A and 4B are flowcharts showing the flow of the productivity maintaining work, and FIG. 4C is a flowchart showing the flow of the productivity improving work;

FIGS. 5A to 5D are views illustrating exemplary display screens, and illustrate an analysis result display screen, a KPI computation defining screen, an MT analysis defining screen, and a status conversion defining screen, respectively;

FIG. 6 is a view illustrating a correspondence relationship between a data structure of a soft-sensor and the display screen;

FIG. 7 is a view illustrating exemplary screens displayed when the frequency of history data is separated;

FIGS. 8A and 8B are views illustrating advantages of an MT method, wherein FIG. 8A illustrates an example of determining a status using the Mahalanobis' distance, and FIG. 8B illustrates an example of displaying raw data of each tag;

FIGS. 9A and 9B are exemplary views illustrating how data are put together, wherein the data are put together for each tag in FIG. 9A, and for each facility in FIG. 9B;

FIG. 10 is an exemplary view illustrating how the data are put together for each procedure;

FIG. 11 is a view illustrating an example of adjusting a phase difference between items;

FIG. 12 is a block diagram illustrating a configuration of a plant analyzing system according to another embodiment; and

FIG. 13 is a block diagram illustrating an exemplary configuration of a distributed field control system.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As described above, in a plant in the related art, workers with different tasks are each working using a different tool. Furthermore, there is no correlation between the respective tools. At present, therefore, a worker has difficulty in sharing manipulation information or operation analysis information of his/her own task with another worker with a different task.

For example, the operator monitors the trends of process data, which largely affects the quality of a product, according to a producing instruction. The production chief checks, based on the trends, whether the amount of finished products will meet the planned volume of production, and also checks the working conditions/schedules of those involved in the production. The operation staff, on the other hand, checks the trends of an operating state of each procedure in the production. The maintenance staff checks the trends of an operating state of a facility.

In the increasingly competitive production scene worldwide, an efficient, value-added and continuously-improving operation, not to mention the stable and safe operation, of a plant is required. Therefore, in addition to the quality of a product, productivity improvement and a reduced lead time are becoming increasingly important as factors to be considered as KPI (key information) in the production scene. Also in the production scene, the workload per person is increasing due to the reduction in workforce. A production system is also changing, which often leads to, for example, limited production of a wide variety of products. This tends to cause various new issues. It is therefore becoming difficult to solve the issues or improve quality in a limited amount of time.

A provider of a control system has developed the method for improving the efficiency in a plant described above. However, further development is considered necessary for the following reasons.

In the first place, in the field of making use of information based on “human decision”, the system has not been established for improving efficiency. In a distributed control system, for example, process data used for operation monitoring and control is collected and stored in a different device from that for facility data. Information a worker seeks is different depending on their task. This makes it necessary for the worker to collect, from different devices, information used for their work. To reduce the lead time, the worker uses a plurality of pieces of information. Since these pieces of information are respectively stored in different devices, the worker has to manually collect each piece of information from the corresponding device.

Also, each worker individually collects information used for their work. This makes it difficult for manipulation information and operation analysis information, collected by the worker, to be shared with another worker with a different task. For example, it is difficult for the operator to quickly reflect, in their productivity maintaining work such as operation monitoring, analysis result and handling information about the productivity improving work of the operation staff or maintenance staff. In contrast, even when the operator who is monitoring production is aware of some abnormality, the operator has difficulty in conveying data and process information on that abnormality to the operation staff or maintenance staff in charge of the productivity improving work.

In this manner, in the system in the related art, works of a plurality of workers with different tasks are not associated (not correlated) with each other.

An object of the present disclosure is to provide a plant analyzing system capable of improving work efficiency by sharing information in a plant.

A plant analyzing system according to the present disclosure analyzes a state of a plant based on data obtained from the plant, and includes: an accepting section that accepts a definition of a soft-sensor for creating key information used for diagnosing the plant based on the data obtained from the plant; a storage section that stores the soft-sensor defined through the accepting section; a monitoring data generating section that generates the key information in real time as data for monitoring the plant based on the data obtained from the plant and using the soft-sensor stored in the storage section; a monitoring data display section that displays in real time the data for monitoring the plant, generated by the monitoring data generating section, on a screen for monitoring an operation; a history data accumulating section that accumulates the data obtained from the plant as history data; and an analyzing data generating section that generates the key information, as data for analyzing a plant state of the past, based on the history data accumulated in the history data accumulating section and using the soft-sensor stored in the storage section.

The plant analyzing system stores the soft-sensor for creating the key information. The key information is generated in real time as the data for monitoring the plant based on the data obtained from the plant and using the stored soft-sensor. Furthermore, the key information is generated as the analyzing data for analyzing the plant state of the past based on the history data and using the stored soft-sensor. Therefore, the information in the plant can be shared through the key information. As a result, the work efficiency can be improved.

The plant analyzing system may further include a logic display section that displays, on the screen for monitoring an operation, a content of the soft-sensor stored in the storage section.

The soft-sensor may include pattern recognition using a Mahalanobis-Taguchi method.

The soft-sensor may include frequency separating processing.

The accepting section may accept a definition of the soft-sensor through the screen for monitoring an operation.

The soft-sensor may include information specifying a method of displaying the data for monitoring the plant using the monitoring data display section.

The plant analyzing system may further include an analyzing data display section that displays the analyzing data generated by the analyzing data generating section, and the soft-sensor may include information specifying a method of displaying the analyzing data using the analyzing data display section.

The information specifying a display method may specify a method of putting together data to be displayed.

The plant analyzing system according to the present disclosure stores the soft-sensor for creating the key information. The key information is generated in real time as the data for monitoring the plant based on the data obtained from the plant and using the stored soft-sensor. Furthermore, the key information is generated as the analyzing data for analyzing the plant state of the past based on the history data and using the stored soft-sensor. Therefore, the information in the plant can be shared through the key information. As a result, the work efficiency can be improved.

A plant analyzing system according to the present embodiment applied to a distributed control system will be described below.

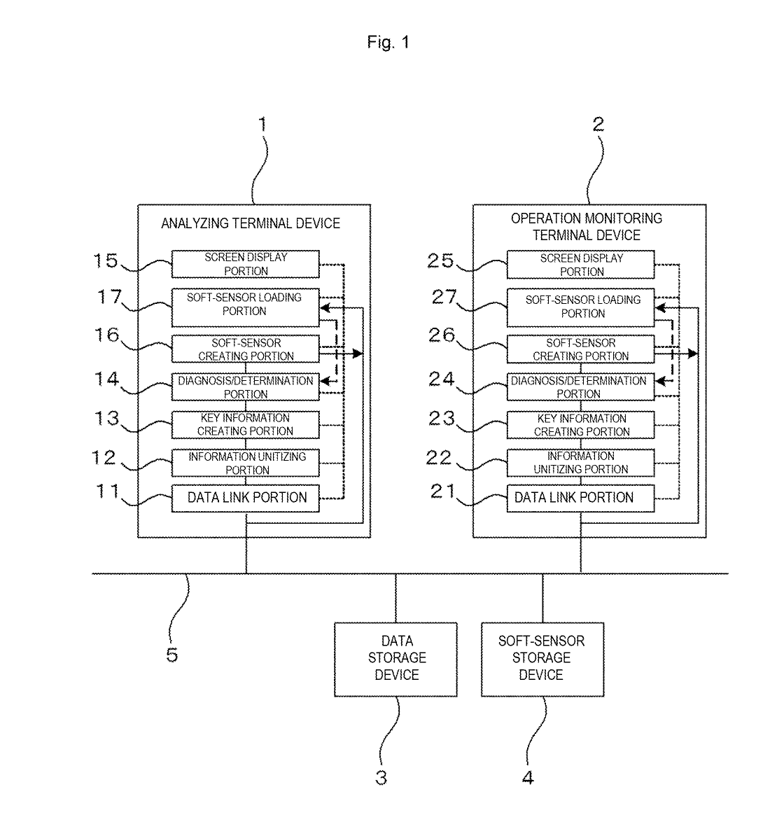

FIG. 1 is a block diagram illustrating a configuration of the plant analyzing system according to the present embodiment.

As illustrated in FIG. 1, the plant analyzing system according to the present embodiment includes an analyzing terminal device 1, an operation monitoring terminal device 2, a data storage device 3 for storing various data, and a soft-sensor storage device 4 for storing a soft-sensor described later. The analyzing terminal device 1 analyzes and diagnoses an operating state of the past in a plant. The operation monitoring terminal device 2 monitors and controls the operating state of the plant in real time through field controllers arranged in a distributed manner at various places in the plant.

Examples of the data and information stored in the data storage device 3 include history data such as process data, process alarm data, and operation manipulation information indicating the content of operation by the operation monitoring terminal device 2, which are obtained from a plant, facility data which is information about facilities in the plant, facility ledger information about the facilities in the plant, procedure control information about processes implemented in the plant, work control information about work to be done in the plant, and production control information about production in the plant.

As illustrated in FIG. 1, the analyzing terminal device 1, the operation monitoring terminal device 2, the data storage device 3, and the soft-sensor storage device 4 are connected to one another via a communication line 5. Note that the connection state of these devices and the method of communication therebetween are arbitrary.

The analyzing terminal device 1 has functions of analyzing/diagnosing the operating state of the past in the plant. Each function will be described below.

### (Data Link Function)

The data link function is provided by a data link portion 11. The data link function is for collecting information, which is used for analysis/diagnosis, from a plurality of data sources stored in, for example, the data storage device 3. Examples of the information to be collected include the history data, facility data, facility ledger information, procedure control information, work control information, and production control information, which are stored in the data storage device 3. The history data includes the process data, the process alarm data, and the operation manipulation information. The history data is stored in the data storage device 3 as time-series data associated with time.

### (Information Unitizing Function)

The information unitizing function is provided by an information unitizing portion 12. The information unitizing function is for putting together pieces of information from an arbitrary viewpoint (e.g., facility and procedure) set by a user, and presenting the gathered information as one information group. In this case, one group of information put together from a specific viewpoint is referred to as “unit”. The information unitizing portion 12 is capable of creating a plurality of units, putting together pieces of information from various viewpoints (items), and presenting the information.

### (Key Information Creating Function)

The key information creating function is provided by a key information creating portion 13. The key information creating function is for defining a logic and/or processing method for creating key information (KPI) used for diagnosing or determining the state of a plant based on the group of information put together as “unit”. Examples of the method for converting the information group into key information, or processing for the conversion will be described below. The method and processing may be appropriately combined to define the logic and the like.

(1) Frequency separating processing using “moving average of data” and/or “difference between raw data and moving average”
(2) Conversion processing using four arithmetic computations and/or logical computation
(3) Conversion processing using statistical processing of, for example, average, maximum and minimum values
(4) Multivariable analysis such as multiple regression analysis
(5) Pattern recognition processing such as Mahalanobis-Taguchi method (MT method)
(6) Diagnosis processing based on the computation results obtained by (1) to (5) above; for example, normal (acceptable quality) in case of a computation value of 50 or more, and abnormal (rejectable quality) in case of a computation value of less than 50

### (Diagnosis/Determination Function)

The diagnosis/determination function is provided by a diagnosis/determination portion 14. The diagnosis/determination function is for detecting a problem and/or analyzing the cause thereof by diagnosis processing using the logic and/or processing method defined by the key information creating function. Examples of the diagnosis processing will be described below.

(1) Comparison of trends using a plurality of trends (history data values of process data) displayed while superimposed;
(2) Analysis of relationship between items using a correlation chart; and
(3) Investigation using various methods for quality control (e.g., method using histogram, pareto chart, check sheet, control chart, cause and effect chart, scatter chart or the like, and stratification method).

### (Screen Display Function)

The screen display function is provided by a screen display portion 15. The screen display function is for displaying, for example, a screen of units defined by the information unitizing portion 12, and a screen of diagnosis results and/or determination results obtained by the diagnosis/determination portion 14. The screen display function also includes a function of displaying a logic and/or processing method of the soft-sensor described later.

### (Soft-Sensor Creating Function)

The soft-sensor creating function is provided by a soft-sensor creating portion 16. The soft-sensor creating function is for creating and registering, as one group called “soft-sensor”, logic and/or processing methods defined by the key information creating portion 13. A plurality of soft-sensors are created like the logic and/or processing methods defined by the key information creating portion 13. The logic and/or processing methods of the created soft-sensors can also be displayed on a screen by the screen display portion 15. This makes it possible to check the logic and/or processing methods. The created soft-sensors are stored in the soft-sensor storage device 4.

### (Soft-Sensor Loading Function)

The soft-sensor loading function is provided by a soft-sensor loading portion 17. The soft-sensor loading function is for loading the soft-sensor stored in the soft-sensor storage device 4. The soft-sensor loaded in the soft-sensor loading portion 17 is not limited to those created by the analyzing terminal device 1 (soft-sensor creating portion 16) but includes those created by the operation monitoring terminal device 2. The logic and/or processing method of the loaded soft-sensor can be checked by, for example, being displayed on a screen. The logic and/or processing method of the loaded soft-sensor can also be used by the diagnosis/determination portion 14. For example, the diagnosis/determination portion 14 processes the history data stored in the data storage device 3 by using the logic and/or processing method of the soft-sensor. This makes it possible to reproduce a problem of the past in the analyzing terminal device 1.

The operation monitoring terminal device 2 will be described next. The operation monitoring terminal device 2 is for monitoring/controlling an operating state of a plant in real time.

The operation monitoring terminal device 2 of the plant analyzing system according to the present embodiment has not only the function of monitoring/controlling an operating state of a plant, but also a similar function to the analyzing terminal device 1. As illustrated in FIG. 1, the operation monitoring terminal device 2 includes a data link portion 21 having the data link function, an information unitizing portion 22 having the information unitizing function, a key information creating portion 23 having the key information creating function, a diagnosis/determination portion 24 having the diagnosis/determination function, a screen display portion 25 having the screen display function, a soft-sensor creating portion 26 having the soft-sensor creating function, and a soft-sensor loading portion 27 having the soft-sensor loading function.

The soft-sensor loaded in the soft-sensor loading portion 27 of the operation monitoring terminal device 2 is not limited to those created by the operation monitoring terminal device 2 but includes those created by the analyzing terminal device 1 (soft-sensor creating portion 16). The logic and/or processing method of the loaded soft-sensor can be checked by, for example, being displayed on a screen. The diagnosis/determination portion 24 processes data such as process data, which is obtained in real time from the plant by the operation monitoring terminal device 2, by using the logic and/or processing method of the loaded soft-sensor. This enables on-line analysis. Furthermore, by processing the history data stored in the data storage device 3, a problem of the past, for example, can be reproduced in the operation monitoring terminal device 2.

Next, usage modes (usage mode 1 and usage mode 2) of the plant analyzing system according to the present embodiment will be described.

### (Usage Mode 1)

With the plant analyzing system according to the present embodiment, when the productivity improving work involves diagnosis processing which enables detection of a certain problem and investigation of a cause thereof, the result of the diagnosis processing can be reflected in the productivity maintaining work.

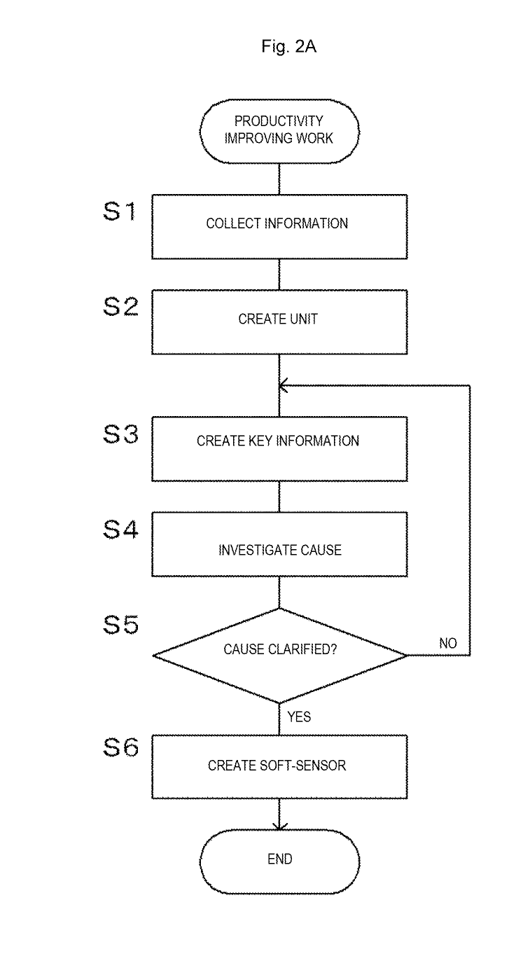

FIG. 2A is a flowchart showing the flow of the productivity improving work in this usage mode, and FIG. 2B is a flowchart similarly showing the flow of the productivity maintaining work.

Steps S1 to S6 of FIG. 2A show the flow of the productivity improving work. The productivity improving work is done by the analyzing terminal device 1.

In step S1 of FIG. 2A, when a problem occurs, productivity improving staff, such as the operation staff and the maintenance staff, manipulates the data link portion 11 of the analyzing terminal device 1 to collect information such as history data from the data storage device 3. In this case, the data link portion 11 collects desired information from among, for example, the history data, facility data, facility ledger information, procedure control information, work control information, and production control information.

Next, in step S2, the productivity improving staff manipulates the information unitizing portion 12 of the analyzing terminal device 1 to create, from the collected pieces of information, a “unit” which is obtained by putting together the information based on the desired viewpoint of the user. In this case, the information unitizing portion 12 selects the desired information from various viewpoints such as product, procedure, and facility.

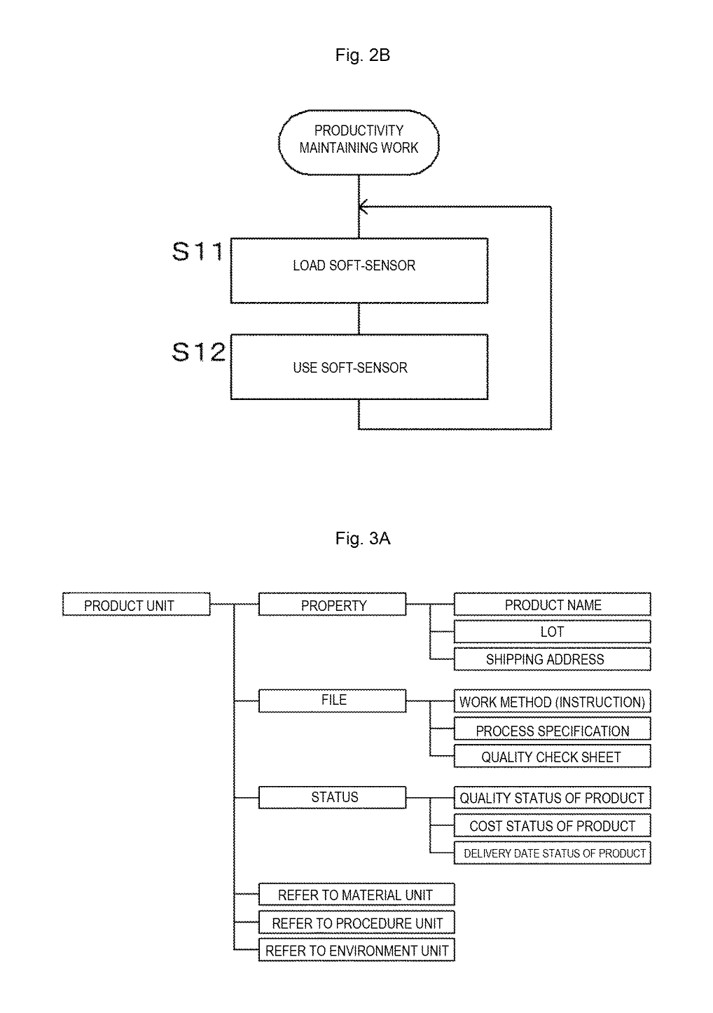

FIG. 3A is a diagram illustrating an exemplary configuration of the “product unit”. FIG. 3B is a diagram illustrating an exemplary configuration of the “procedure unit”.

The product unit is based on a product produced in a plant. The product unit is a group of information obtained by putting together data relating to each stage of producing the product from materials. In the example illustrated in FIG. 3A, data relating to the product are stored while being classified into categories of “property” indicating attributes of the product, “file” indicating image files relating to the product, and “status” indicating statuses relating to the product. In addition, a material unit, a procedure unit, and an environment unit are set as the units that can be referenced by developing a display screen corresponding to the product unit.

The procedure unit is based on the procedures for producing the product. The procedure unit is a group of information obtained by putting together data indicating a relationship between the procedures and/or data relating to the procedures. In the example illustrated in FIG. 3B, the data relating to the procedures are stored while being classified into categories of “property” indicating attributes of the procedures, and “flow” indicating data relating to the flow of production. In addition, a person unit and a device unit are set as the units that can be referenced by developing a display screen corresponding to the procedure unit.

Next, in step S3, the productivity improving staff manipulates the key information creating portion 13 of the analyzing terminal device 1 to define a logic and/or processing method for creating, from the unitized information, key information used by the user for diagnosis/determination. In this case, the key information creating portion 13 defines the logic and/or processing method.

Next, in step S4, the productivity improving staff manipulates the diagnosis/determination portion 14 of the analyzing terminal device 1 to attempt to detect a problem and/or investigate a cause of abnormality, by using the logic and/or processing method defined in step S3 to convert the unitized information into key information. If the above step results in successful detection of a problem and/or investigation of a cause of abnormality (YES in step S5), the flow goes to step S6. If the detection of a problem and/or investigation of a cause of abnormality fail (NO in step S5), the flow returns to step S3, where the logic and/or processing method for creating key information are reconsidered.

In step S6, the productivity improving staff manipulates the soft-sensor creating portion 16 of the analyzing terminal device 1 to create a soft-sensor from the logic and/or processing method defined in step S3 and store the soft-sensor in the soft-sensor storage device 4. With the above flow, the processing of the productivity improving work is finished.

Steps S11 and S12 of FIG. 2B show the flow of the productivity maintaining work. The productivity maintaining work is done by the operation monitoring terminal device 2.

In step S11 of FIG. 2B, productivity maintaining staff manipulates the soft-sensor loading portion 27 of the operation monitoring terminal device 2 to obtain the soft-sensor stored in step S6 from the soft-sensor storage device 4.

Next, in step S12, the productivity maintaining staff manipulates to use the soft-sensor loaded in step S11.

En this case, for example, the key information creating portion 23 of the operation monitoring terminal device 2 can convert the current plant data into key information in real time using the soft-sensor. With the above process, the states of the plant can be converted into numeric values in real time. Therefore, for example, the screen display portion 25 of the operation monitoring terminal device 2 can graphically display the states of the plant. When the soft-sensor includes a logic for distinguishing between normal and abnormal, it is possible to know in real time whether the current state is normal or abnormal. Therefore, the analysis result obtained by the soft-sensor can be effectively used for monitoring/controlling the plant.

Furthermore, the logic and/or processing method itself of the soft-sensor can be displayed on a screen in the operation monitoring terminal device 2. This allows the productivity maintaining staff to understand the logic and/or processing method. Through the soft-sensor, therefore, the information about the analysis of the plant (e.g., analyzing procedure) can be widely shared between the productivity improving staff and the productivity maintaining staff.

### (Usage Mode 2)

When a problem occurs in monitoring/control by the operation monitoring terminal device 2 of the plant analyzing system according to the present embodiment, the productivity improving staff can investigate the problem by loading the past data of the time of problem occurrence in the analyzing terminal device 1 and reproducing the situation of the time of problem occurrence.

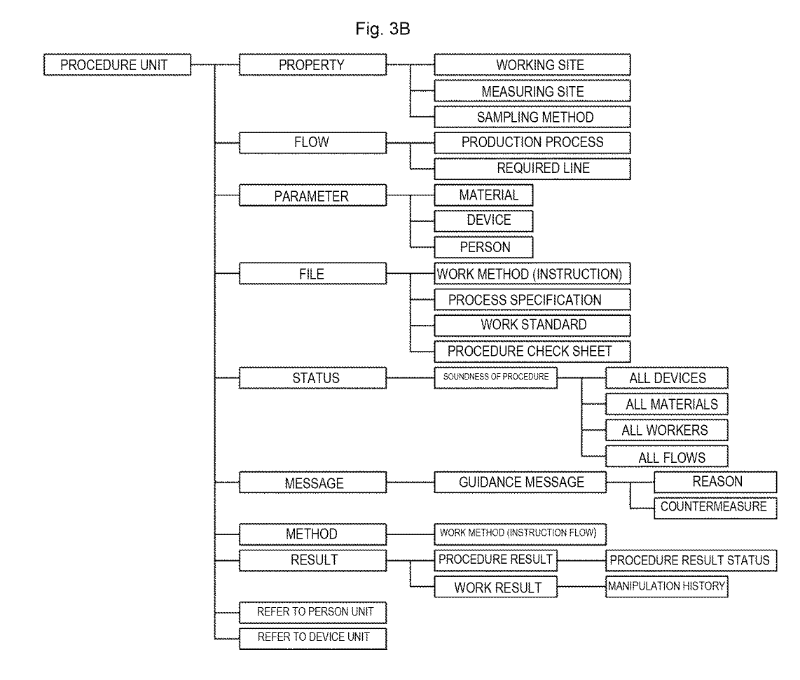

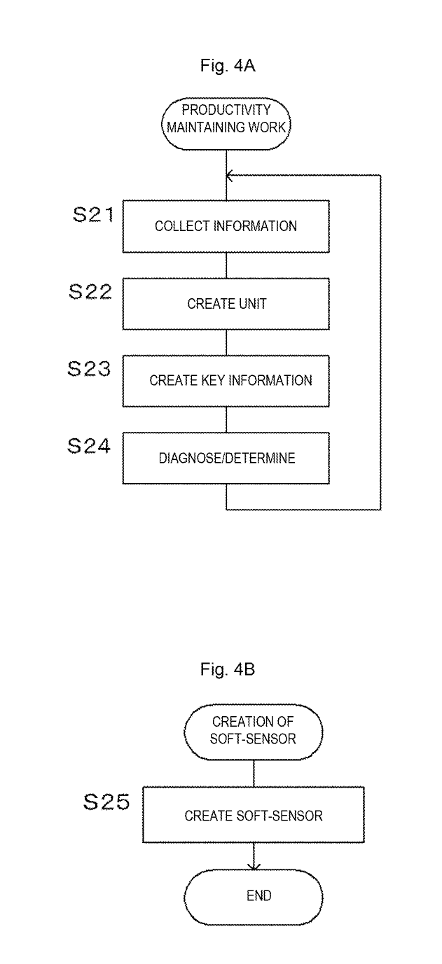

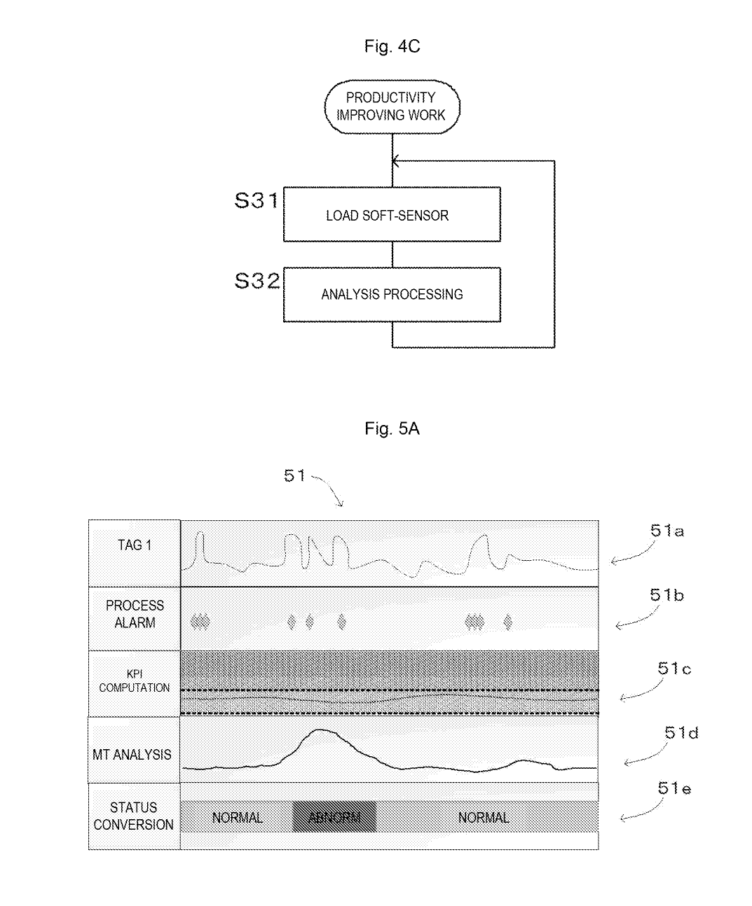

FIGS. 4A and 4B are flowcharts showing the flow of the productivity maintaining work in this usage mode. FIG. 4C is a flowchart similarly showing the flow of the productivity improving work.

Steps S21 to S25 of FIGS. 4A and 4B show the flow of the productivity maintaining work. The productivity maintaining work is done by the operation monitoring terminal device 2.

In step S21 of FIG. 4A, the productivity maintaining staff such as an operator manipulates the data link portion 21 of the operation monitoring terminal device 2 to collect information in real time from a data source of the plant for the purpose of operation monitoring.

Next, in step S22, the productivity maintaining staff manipulates the information unitizing portion 22 of the operation monitoring terminal device 2 to create, from the collected pieces of information, a “unit” which is obtained by putting together the information based on the desired viewpoint of the user. In this case, the information unitizing portion 22 selects the desired information from various viewpoints such as product, procedure, and facility.

Next, in step S23, the productivity maintaining staff manipulates the key information creating portion 23 of the operation monitoring terminal device 2 to define a logic and/or processing method for creatine, from the unitized information, key information used by the user for diagnosis/determination.

Next, in step S24, the productivity maintaining staff manipulates the diagnosis/determination portion 24 of the operation monitoring terminal device 2 to perform diagnosis/determination in real time. The diagnosis/determination portion 24 converts the unitized information into key information in real time by using the logic and/or processing method defined in step S23. The productivity maintaining staff performs the diagnosis/determination based on the key information.

As described above, the productivity maintaining staff can monitor the operation of the plant in real time based on the key information by repeating the works of steps S21 to S24.

When a problem occurs in the productivity maintaining work, the productivity maintaining staff performs the work of step S25 shown in FIG. 4B in response to, for example, a request from the productivity improving staff.

Step S25 allows the productivity improving staff to analyze the situation of the time of problem occurrence. For this purpose, the productivity maintaining staff manipulates the soft-sensor creating portion 26 of the operation monitoring terminal device 2 to create a soft-sensor from the logic and/or processing method used at the time of problem occurrence for creating the key information. The created soft-sensor is stored in the soft-sensor storage device 4.

The productivity improving staff manipulates the analyzing terminal device 1 to perform steps S31 and S32 shown in FIG. 4C using the soft-sensor created and stored in step S25.

In step S31, the productivity improving staff manipulates the soft-sensor loading portion 17 of the analyzing terminal device 1 to obtain the soft-sensor stored in step S25 from the soft-sensor storage device 4.

Next, in step S32, the productivity improving staff can manipulate the diagnosis/determination portion 14 of the analyzing terminal device 1 to check the conversion processing to key information by the logic and/or processing method of the soft-sensor obtained in step S31. For example, the diagnosis/determination portion 14 obtains the history data of the time of problem occurrence from the data storage device 3. Furthermore, the diagnosis/determination portion 14 performs the conversion to the key information based on the history data. This also makes it possible to reproduce the situation of the time of problem occurrence. Therefore, it is possible to analyze problems and the like present in the logic and/or processing method.

The works in steps S1 to S6 (FIG. 2A) make it possible to create a new logic and/or processing method used for detection of the problem and/or analysis of a cause thereof. In this case, the created logic and/or processing method can be stored in the soft-sensor storage device 4 as a soft-sensor. As described above, the soft-sensor stored in the soft-sensor storage device 4 can be used by being loaded in the operation monitoring terminal device 2 in the productivity maintaining work.

Sharing the information through the soft-sensor in this manner allows the productivity improving staff to, when a problem occurs in the productivity maintaining work, reproduce and analyze the situation of the time of problem occurrence. The productivity improving staff can also create a new logic and/or processing method used for detection of a problem and/or analysis of a cause thereof, and register the logic and/or processing method as a soft-sensor.

As described above, with the plant analyzing system according to the present embodiment, the information about analysis of a plant can be shared between the productivity improving staff and the productivity maintaining staff through the soft-sensor. Therefore, the lead time can be reduced both in the productivity improving work and the productivity maintaining work.

For example, the cooperation between the staff in the both works can solve a problem, which has hitherto not been solved due to lack of cooperation arising from the usage of different tools. In the case of no cooperation, the staff in the both works individually performs the same processing. With the plant analyzing system according to the present embodiment, such redundant work can be eliminated.

Also with the plant analyzing system according to the present embodiment, information about the productivity maintaining work and the productivity improving work can be stored in the soft-sensor storage device 4. Furthermore, the information can be freely used, as shared information, both in the productivity maintaining work and the productivity improving work.

For example, know-how for diagnosis/determination respectively obtained in the productivity maintaining work and the productivity improving work is accumulated as a soft-sensor. The soft-sensor can be used as the shared information. Also, the accumulation of know-how makes it possible to objectify, for example, an operating method of a good operator through key information. Therefore, the know-how can be effectively used as the information for supporting the operation.

Furthermore, the “unit” can be used to freely select a viewpoint of information. Therefore, the same system can be used for various applications in the production work.

The operation of a plant generally involves workers with various tasks (e.g., production chief, operation staff, maintenance staff, and operator). The workers each perform monitoring and analysis from the viewpoints of, for example, “facility”, “procedure”, “quality”, “person”, and “material/energy” according to their own task. With the plant analyzing system according to the present embodiment, information can be unitized from the desired viewpoint of the user. Therefore, the plant analyzing system can be used for various applications (FIGS. 3A and 3B).

From the viewpoint of “procedure”, for example, the analyzing terminal device 1 can analyze the “procedure”. Also, the operation monitoring terminal device 2 can monitor information about the “procedure” in real time.

The “procedure unit” is created by the analyzing terminal device 1 or the operation monitoring terminal device 2 collecting and registering the information about the procedure from a plurality of data sources. The productivity improving staff can analyze a problem in the procedure by using the information included in the “procedure unit”. For example, the productivity improving staff can investigate a cause of the problem by comparing information about the procedure of the past with information about the procedure having the problem. The logic and/or processing method used for analysis is stored in the soft-sensor storage device 4 in the form of a soft-sensor.

The productivity maintaining staff, on the other hand, can monitor not only raw data but also processing information about the procedure in real time by using the soft-sensor.

From the viewpoint of “facility”, for example, the analyzing terminal device 1 can analyze the “facility”. Also, the operation monitoring terminal device 2 can monitor information about the “facility” (e.g., facility tendency information) in real time.

The “facility unit” is created by the analyzing terminal device 1 or the operation monitoring terminal device 2 collecting and registering the information about the facility from a plurality of data sources. The maintenance staff in charge of the productivity improving work can analyze a problem regarding the facility tendency information by using the information included in the “facility unit”. The maintenance staff can investigate a cause of deterioration of the facility by comparing long-term tendencies of the facility, that is, for example, by looking into a difference in facility tendency between last year and current year.

On the other hand, the maintenance staff in charge of the productivity maintaining work can monitor, for example, the change in state of the facility over a relatively short period, by using the information included in the “facility unit” through the operation monitoring terminal device 2. The maintenance staff can also check the current state of the facility, and monitor how the facility is used or performance level of the facility.

As described above, with the plant analyzing system according to the present embodiment, it is possible to efficiently access a plurality of pieces of information corresponding to the respective applications in the production work by using the concept of “unit” to switch the viewpoints such as “facility” or “procedure”.

Note that a storage device may be provided for each unit so that respective types of information such as “procedure unit” and “facility unit” are stored separately. Furthermore, the system may be divided according to each unit.

The plant analyzing system according to the present embodiment can also allow an operating method of an operator to be shared.

Generally in the production scene, a mechanism for passing down an operating method and skills of a good, experienced operator has been demanded. At present, the operators individually have their own know-how for operation. Therefore, for example, retirement of the operator makes it difficult to pass down the know-how.

In contrast, with the plant analyzing system according to the present embodiment, the soft-sensor creating portion 26 of the operation monitoring terminal device 2 can store, as the soft-sensor, the logic and/or processing method used by a good operator to determine an operating state. The soft-sensor loading portion 27 of the operation monitoring terminal device 2 can load the soft-sensor. This allows other operators to perform a similar operation by using this soft-sensor. The other operators can also directly understand detailed operation know-how corresponding to manipulation content, manipulation amount, and process data with reference to the logic and/or processing method itself stored as the soft-sensor. With the soft-sensor described above, for example, the present system can be used as a navigation system for a new operator.

Also with the plant analyzing system according to the present embodiment, operation information of the past can be effectively used.

In the production scene, products of the same type are often produced. To keep a predetermined quality, however, a manipulation method and/or manipulation amount somewhat differ from day to day due to, for example, seasonal fluctuations in environment of the production scene. Such operation information is not turned into data in the related art. Therefore, the operation information is not effectively used. Upon recognizing an imminent problem while monitoring the operation, an experienced operator takes a preemptive measure to prevent the problem in many cases. However, operation information in such cases is not turned into data, either.

The plant analyzing system according to the present embodiment, on the other hand, can store, as the soft-sensor, the logic and/or processing method for determining a daily operating state. The operator and the like can use or refer to the soft-sensor at any time. When the current operating state is similar to the operating state of the past, the soft-sensor can be used as effective operation supporting information by using the logic and/or processing method used in the operating state of the past. In addition, when the current operating state is similar to the past state of the time of problem occurrence, the productivity improving staff, for example, can predict the change in trends in the future by using the soft-sensor. When the prediction result shows unstable trends, the productivity improving staff can also take countermeasures such as notifying the productivity maintaining staff of the result.

With the plant analyzing system according to the present embodiment, as described above, the Mahalanobis-Taguchi method (MT method) can be used as a pattern recognition technique for analyzing the state of a plant. The MT method is an information processing technique for recognizing patterns based on multidimensional information. The MT method makes it possible to detect whether the current state is normal and, if not, determine a cause of the abnormality. As a result, it is possible to obtain information indicating whether the facility/equipment is operating normally, or to what extent the current state can be considered similar to the state hitherto regarded as normal. The technique for analyzing the operation of a plant with the MT method is disclosed in, for example, Japanese Patent Application Laid-Open No. 2007-213194.

When the Mahalanobis-Taguchi method (MT method) is used as the pattern recognition technique for analyzing the state of a plant, off-line analysis using the MT method is performed in the productivity improving work. As a result, when a condition and/or logic for detecting abnormality or the like can be created, the condition and/or logic can be used for the on-line analysis as a monitoring logic in the productivity maintaining work. The work procedures (procedures 1 to 4) will be described below.

### (Procedure 1)

In the productivity improving work, the operation staff uses the analyzing terminal device 1 to attempt analysis by the MT method based on history data. The analyzing terminal device 1 performs the analysis by the MT method based on the history data under various conditions. In this manner, the analyzing terminal device 1 finds an analyzing condition under which a cause of abnormality or the like can be determined.

### (Procedure 2)

When the analyzing condition under which a cause of abnormality or the like can be determined is found, the analyzing terminal device 1 stores the analyzing condition in the soft-sensor storage device 4 as a soft-sensor. In this case, the operation staff reports to, for example, the production chief about the result of cause investigation. As a future measure, the operation staff further notifies the operator in charge of the productivity maintaining work that the soft-sensor available for abnormality analysis has been created.

### (Procedure 3)

The operator manipulates, where necessary, the operation monitoring terminal device 2 to load the soft-sensor from the soft-sensor storage device 4. The operation monitoring terminal device 2 incorporates the analyzing condition of the loaded soft-sensor into monitoring processing based on the manipulation by the operator, and sets, for example, parameters and a monitoring cycle.

### (Procedure 4)

After the analyzing condition is incorporated, the operator manipulates the operation monitoring terminal device 2 to start the monitoring processing. As a result, an analyzing content according to the analyzing condition created in the productivity improving work is reflected as it is in the on-line analysis. This allows the operator to monitor the abnormality on the screen of the operation monitoring terminal device 2. In this case, the analysis result obtained by the MT method indicates the similarity between the current state and the abnormal state. Therefore, the operator can predict the occurrence of abnormality relatively in an early stage. As a result, a prompt and appropriate measure can be taken.

In this manner, with the MT method, the operator can notice a predictive stage with a deteriorating balance among plural data, not the stage immediately before the occurrence of abnormality. For example, it may be possible to detect an imminent abnormality several hours before the occurrence thereof. The earlier the detection timing, the more time the operator has to take a countermeasure. This makes it easy to prevent the abnormality in advance. The MT method also makes it possible to maintain the quality and improve the productivity, as well as reducing the lead time for analysis.

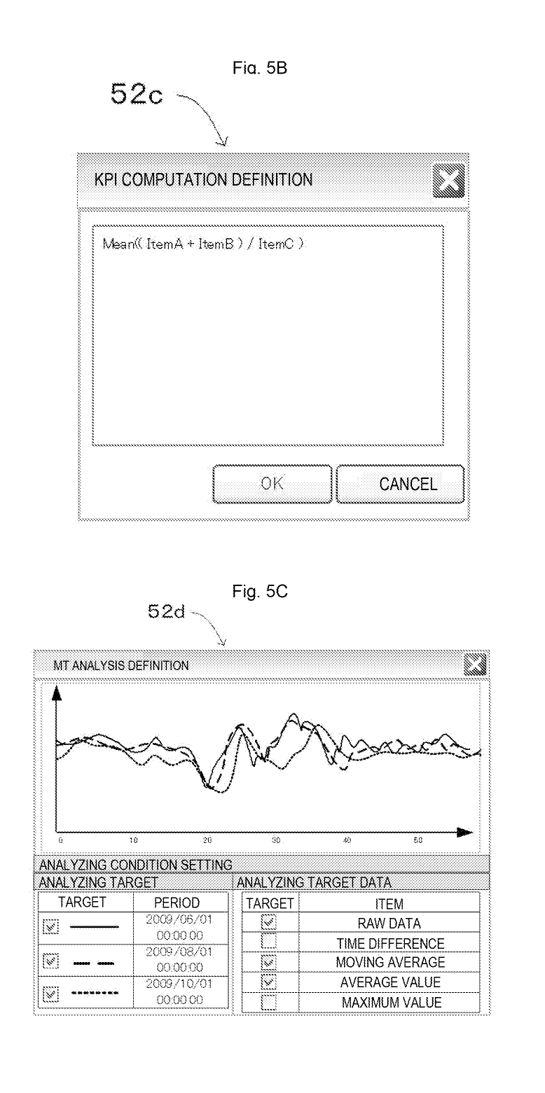

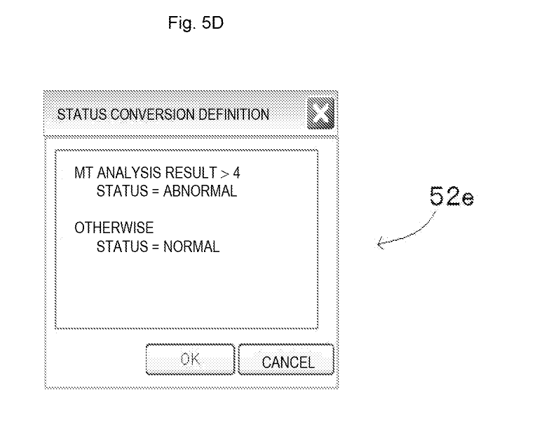

Next, the content and the like of the logic or soft-sensor, which is used for analysis in the plant analyzing system according to the present embodiment, will be described with reference to FIGS. 5A, 5B and 5C to FIGS. 8A and 8B and based on, for example, screens displayed on the analyzing terminal device 1 and the operation monitoring terminal device 2. These screens are displayed by the screen display portions 15 and 25 of the analyzing terminal device 1 and the operation monitoring terminal device 2, respectively.

FIG. 5A illustrates an example of the analysis result display screen displayed on the analyzing terminal device 1 or the operation monitoring terminal device 2.

In the example of FIG. 5A, regions 51a to 51e are provided on an analysis result display screen 51. A history of values of predetermined process data (TAG 1) is displayed in the region 51a. A history of occurrence of a predetermined process alarm is displayed in the region 51b. A history of key information (KPI) defined by a computation formula is displayed in the region 51c. An analysis result obtained by the MT method according to a predetermined definition is displayed in the region 51d. A history of a status according to a predetermined definition is displayed in the region 51e. Graphs having a horizontal time axis in common are displayed in the respective regions 51a to 51e. These graphs each show, for example, the corresponding history and analysis result. The analysis result by the MT method displayed in the region 51d and the status displayed in the region 51e correspond to the key information (KPI) or the history thereof.

The history of values of process data displayed in the region 51a and the history of process alarm displayed in the region 51b are obtained from, for example, the data storage device 3 by the data link portion 11 of the analyzing terminal device 1 and the data link portion 21 of the operation monitoring terminal device 2, respectively.

FIG. 5B illustrates a KPI computation defining screen 52c, to be displayed in the region 51c, for defining a computation formula of key information (KPI). The user can define the computation formula of key information (KPI) on the KPI computation defining screen 52c through the analyzing terminal device 1 and the operation monitoring terminal device 2. The defined content constitutes part of information of the soft-sensor and is stored in the soft-sensor storage device 4.

FIG. 5C illustrates an MT analysis defining screen 52d, to be displayed in the region 51d, for defining an analyzing method using the MT method. The user can define the analyzing method using the MT method on the MT analysis defining screen 52d through the analyzing terminal device 1 and the operation monitoring terminal device 2. The defined content constitutes part of the information of the soft-sensor and is stored in the soft-sensor storage device 4.

FIG. 5D illustrates a status conversion defining screen 52e, to be displayed in the region 51e, for defining the content of the status. The user can define the content of the status on the status conversion defining screen 52e through the analyzing terminal device 1 and the operation monitoring terminal device 2. In the example of FIG. 5D, the content of the status is defined such that the analysis result obtained by analysis using the MT method according to the definition of the MT analysis defining screen 52d (FIG. 5C) is reflected in the status (normal/abnormal). The defined content constitutes part of the information of the soft-sensor and is stored in the soft-sensor storage device 4.

The contents defined on the defining screens illustrated in FIGS. 5B to 5D are registered as the soft-sensors (stored in the soft-sensor storage device 4). Through the user manipulation, the analyzing terminal device 1 and the operation monitoring terminal device 2 load the registered soft-sensors and display a screen in the form corresponding to FIG. 5A using the defined contents of the soft-sensors. As a result, the user can analyze a plant using the screen. Through the user manipulation, the analyzing terminal device 1 and the operation monitoring terminal device 2 can also load the registered soft-sensors and display a screen showing the defined contents themselves of the soft-sensors, that is, the defining screens illustrated in FIGS. 5B to 5D or screens displaying similar contents to the defining screens. This allows the user to freely refer to, for example, the logic for analysis registered as the soft-sensor.

In the example of FIG. 5A, the analysis result obtained by the MT method is used to determine the status (normal/abnormal). Once such an analyzing logic or processing method is found effective, the analyzing terminal device 1 or the operation monitoring terminal device 2 can, through the user manipulation, register the analyzing logic or the like as the soft-sensor. The case where the analyzing logic or processing method is found effective as described above is not limited to the productivity improving work or the productivity maintaining work. Also, the case where the registered soft-sensor is used is not limited to the productivity improving work or the productivity maintaining work. The productivity maintaining staff can use the soft-sensor registered by the productivity improving staff, and vice versa. In this manner, the information about plant analysis can be shared by making it possible to register and use the soft-sensor both in the productivity improving work and the productivity maintaining work.

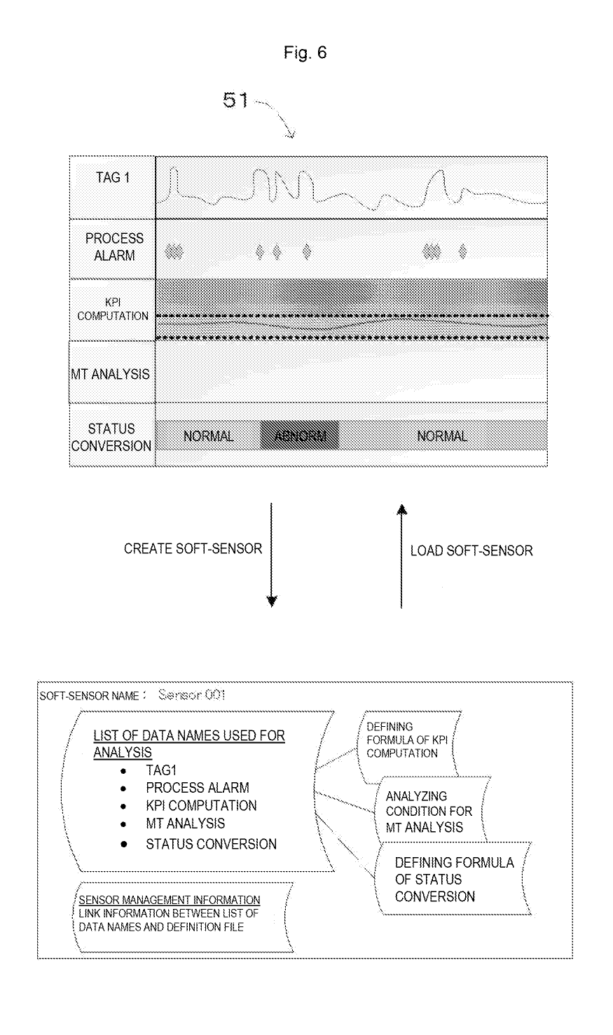

FIG. 6 is a view illustrating a correspondence relationship between a data structure of the soft-sensor and the display screen.

As illustrated in FIG. 6, the soft-sensor includes a list of data names used for analysis, definitions of key information contained in these data, and sensor management information for linking the data with definition files. FIG. 6 illustrates an example of the correspondence relationship between the analysis result display screen 51 illustrated in FIG. 5A and the soft-sensor. The list of data names corresponds to the data displayed in the regions 51a to 51e. The definitions of key information correspond to the defined contents in the defining screens illustrated in FIGS. 5B to 5D. Through the user manipulation, the analyzing terminal device 1 or the operation monitoring terminal device 2 displays the contents of the soft-sensor (list of data names and definitions of key information) on the screen. This allows the user to directly learn the analyzing logic or processing method as described above.

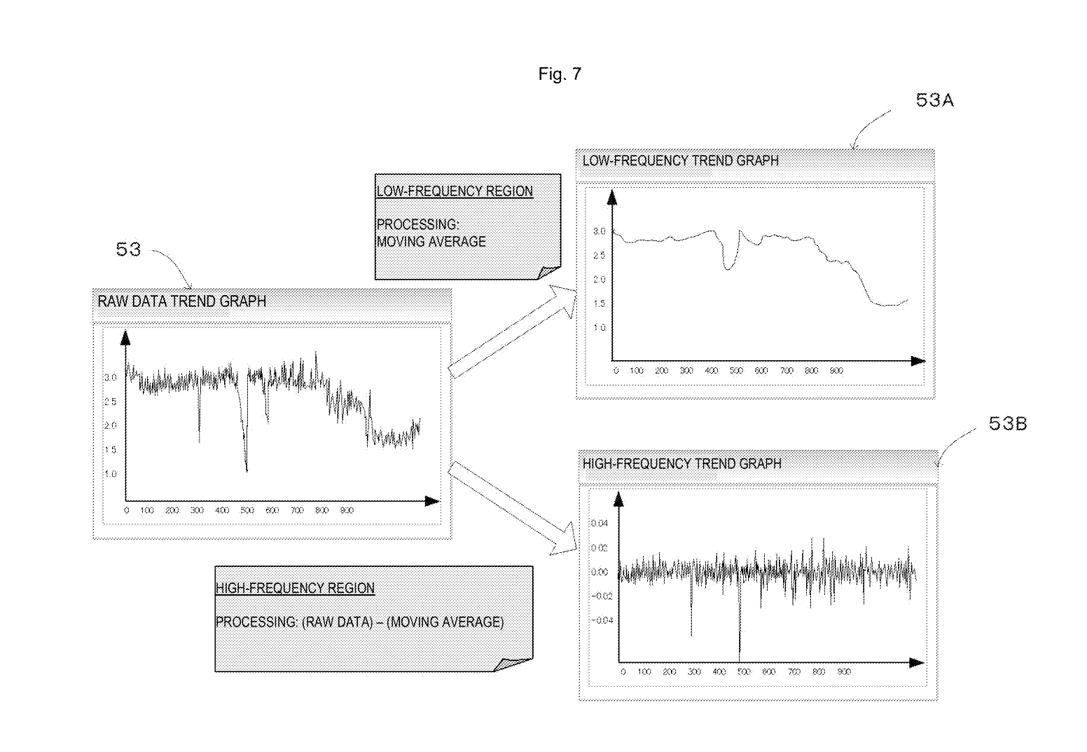

FIG. 7 is a view illustrating exemplary screens displayed when the frequency of history data is separated using “moving average of data”. As described above, the frequency separating processing is used as a method for defining, for example, a logic.

In the example of FIG. 7, raw data is illustrated as a trend graph screen 53. Moving average of the raw data (low-frequency region) is illustrated as a trend graph screen 53A. A difference between the raw data and the moving average (high-frequency region) is illustrated as a trend graph screen 53B. The data obtained through such processing can be used to define key information. For example, erroneous detection of abnormality occurrence resulting from transitional behaviors can be prevented by defining a status using the data in the low-frequency region. The frequency separating processing can be widely applied not only to the raw data such as history data but also to key information in the form of time function.

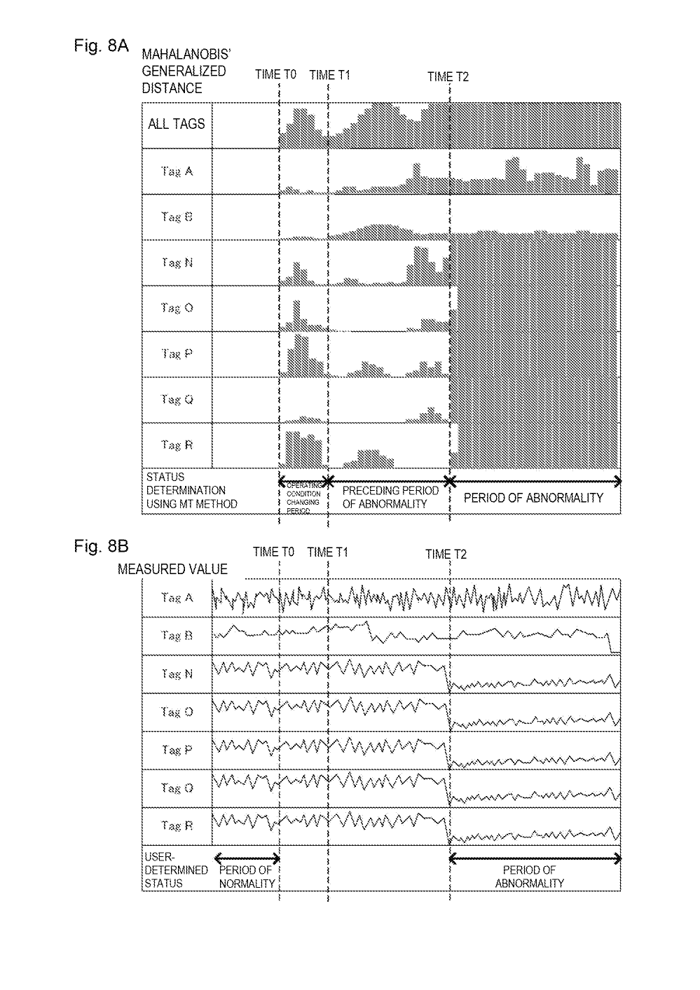

FIGS. 8A and 8B are views illustrating advantages of the MT method, which is an example of the logic for creating key information (KPI) in the present embodiment. FIG. 8A illustrates an example of determining a status using the Mahalanobis' distance in each tag (process data). The Mahalanobis' distance indicates a distance between a group of history data determined to be normal and a group of data to be analyzed. The large Mahalanobis' distance indicates that a state of each tag is far from a normal pattern. In the example of FIG. 5A, the Mahalanobis' distance of each tag (tags A, B, N, . . . in FIG. 8A) and the sum of the Mahalanobis' distances (“all tags” in FIG. 8A) are defined as the key information. The status is determined based on the sum of the Mahalanobis' distances. FIG. 8B, on the other hand, illustrates an example of displaying raw data of each tag corresponding to the status determination of FIG. 8A. The time of FIG. 8B corresponds to the time of FIG. 8A.

As illustrated in FIG. 8A, the Mahalanobis' distance increases as the state of a plant is close to being abnormal. Therefore, the occurrence of abnormality can be detected by monitoring the Mahalanobis' distance. In the example of FIG. 8A, it can be determined that abnormality has occurred at time t2. As illustrated in FIG. 8A, when the operating condition is switched at time t0, the Mahalanobis' distance is kept reduced as a whole from time t0 until a steady state is achieved. At time t1, however, the Mahalanobis' distance starts to increase, based on which a sign of the imminent abnormality can be recognized. Therefore, it is possible to predict the occurrence of abnormality prior to time t2 at which the status turns abnormal.

In contrast, as with the system in the related art, it is difficult for the operator to notice a sign of abnormality with a screen display of only raw data of each tag illustrated in FIG. 8B.

In this manner, the operator can predict the occurrence of abnormality relatively in an early stage by displaying the screen illustrated in FIG. 8A on the operation monitoring terminal device 2 using the MT method. This allows the operator to take a prompt and appropriate measure to avoid the occurrence of abnormality.

As described above, the plant analyzing system according to the present embodiment can provide a tool which can be shared between, and can allow information to be shared between, the productivity maintaining work and the productivity improving work. As a result, the productivity maintaining staff can promptly reflect a problem and/or countermeasure therefor, which are found in the productivity improving work, in the operation of a plant. The productivity improving staff can promptly find and analyze a problem in the processing of the plant operation.

The plant analyzing system according to the present embodiment allows information to be shared between the productivity maintaining work and the productivity improving work through the soft-sensor. That is, the present system can realize the cooperation between the both works. This can speed up the work cycle, and thus reduce the production lead time. It is also possible to solve a problem and/or improve quality in a short time.

Next, constituent elements and the like of the soft-sensor used in the plant analyzing system according to the present embodiment will be described.

Generally with the method using the soft-sensor, a numerical model is established which associates a variable that is measurable on-line with a variable that is difficult to measure. Then, the target variable that is difficult to measure is estimated based on the measurable variable. The use of the soft-sensor makes it possible to find a process variable and/or various indices, which are difficult to measure, without using an analyzing device or the like.

The constituent elements of the soft-sensor used in the plant analyzing system according to the present embodiment can be classified into four categories, i.e., (1) data structure, (2) method of putting data together, (3) definition of data processing, and (4) item preprocessing information. Each of the constituent elements will be described below.

### (1) Data Structure

Examples of the data structure include “item name of process data”, “event name”, “data conversion item name”, “computation item name”, “monitoring status conversion item name”, and “MT analysis item name”.

The “item name of process data” is a tag name of process data used for analysis or monitoring. For example, in the case where the process data is obtained for analysis, a data source (tag name) of the process data is the “item name of process data”.

The “event name” is an event name or a type of event used for analysis or monitoring. Examples of the “event name” include process alarm, system alarm, operation guidance message, engineering maintenance message, manipulation history, custom-made message, and internal error of server.

The “data conversion item name” indicates the type of processing applied to one piece of process data. Examples of the “data conversion item name” include time difference, moving average, and difference between raw data and moving average.

The “computation item name” indicates the type of computation performed using a plurality of items such as process data.

The “monitoring status conversion item name” indicates a monitoring status using, as a condition, values of items such as process data. The monitoring status is, for example, “High” when a data value of a specific process value is 50 or more, “Normal” when the data value is 20 or more and less than 50, and “Low” when the data value is less than 20.

The “MT analysis item name” indicates the MT analyzing processing applied to values of a plurality of items such as process data.

### (2) Method of Putting Data Together

The method of putting data together is a method of displaying a monitoring result and/or analysis result. Data are put together for each “tag”, “facility” or “procedure”. Display based on each display method is enabled by defining display items for each display method (method of putting together).

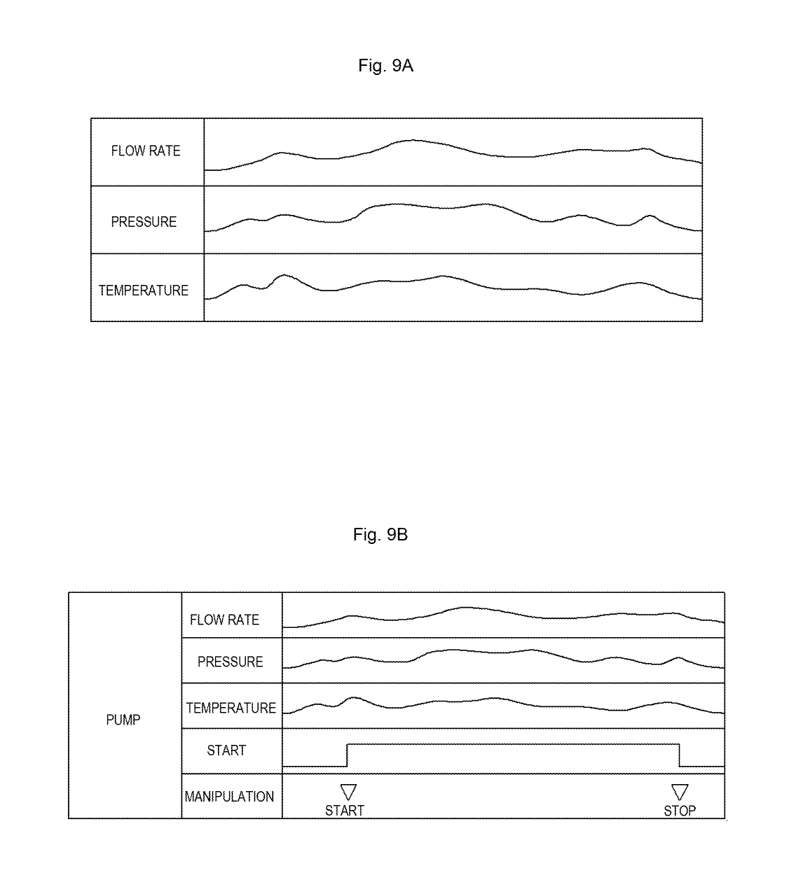

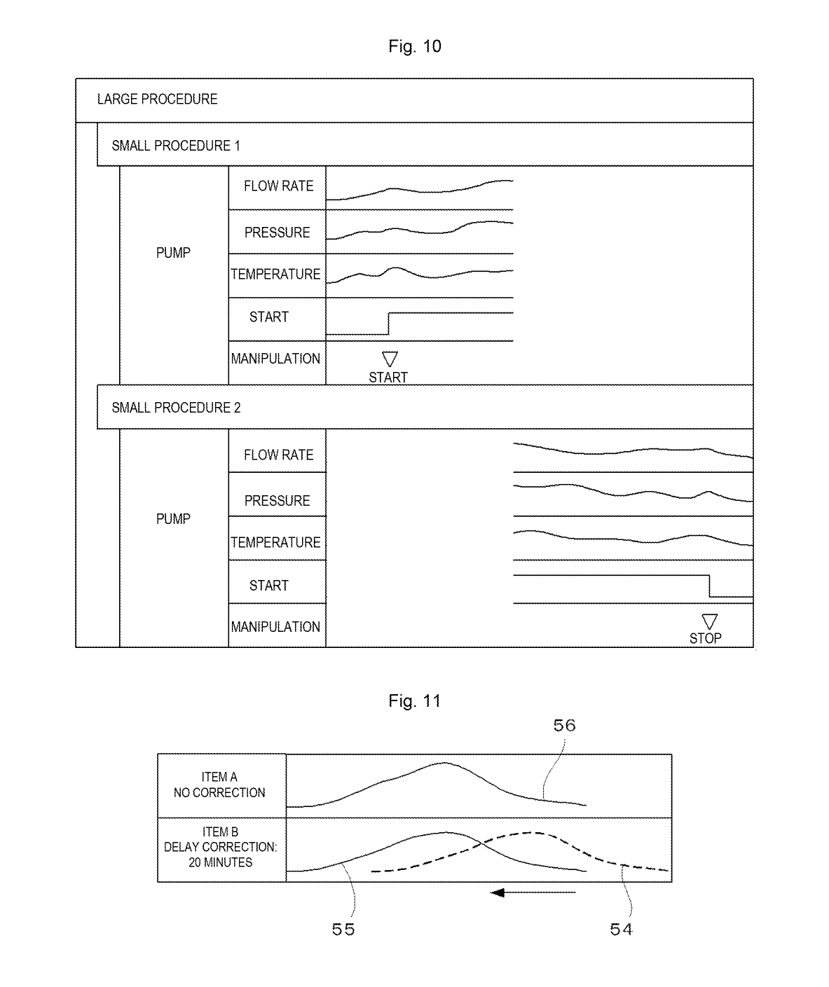

FIGS. 9A, 9B, and 10 are exemplary views illustrating the method of putting data together.

FIG. 9A illustrates an example of the method of putting data together for each “tag”, that is, a method of displaying process values and the like for each tag name. In this example, trends of flow rate, pressure, and temperature of a specific tag are shown.

FIG. 9B illustrates an example of putting data together for each “facility”, that is, a method of collectively displaying process data and events from the viewpoint of facility (for each facility name). In this example, trends of process data and the like put together from the viewpoint of facility (pump) are shown.

FIG. 10 illustrates an example of putting data together for each “procedure”, that is, a method of displaying process data and events from the viewpoint of procedure (for each procedure). In this example, a sequence of procedures (large procedure) is divided into partial procedures (small procedure 1, small procedure 2, and so on). Trends of process data and the like are shown for each partial procedure.

### (3) Definition of Data Processing

The definitions of data processing include “data conversion”, “computation processing”, “monitoring status conversion”, and “MT computation”.

Examples of the “data conversion” include, as illustrated in FIG. 7, processing for extracting only low-frequency components by calculating moving average of process data, and processing for extracting high-frequency components by calculating a difference between raw data and moving average. As described above, the soft-sensor information includes information indicating the preprocessing the operation staff or operator has performed.

The “computation processing” includes “definition of computation” using, for example, addition, subtraction, multiplication, division, logical computation, and exponential computation, an “item list” specifying items used in the computation, and a “threshold” providing standards and the like for determining a computation result.

The “monitoring status conversion” includes “definition of computation” for monitoring using, for example, addition, subtraction, multiplication, division, logical computation, exponential computation, and definition of condition (definition of if-clause). The “monitoring status conversion” further includes an “item list” specifying items used in the computation, and a “threshold” providing standards and the like for determining a computation result.

The “MT computation” includes “MT analyzing condition definition” described later, an “item list”, “unit space data”, and a “threshold”. The “item list” specifies items used as standard data. The “unit space data” specifies spatial data of the time of creating the unit space. The “threshold” is a standard value for determining the computation result of an MT distance. The “MT analyzing condition definition” includes, for each item, “feature amount to be used”, “the positions of sample lines”, “the number of sample lines”, “a value of each sample line”, and “an interval (cycle) of analysis”.

### (4) Item Preprocessing Information

The item preprocessing information is, for example, “phase adjusting information”. The “phase adjusting information” is for adjusting a gap (phase difference) between trends of a plurality of items.

FIG. 11 illustrates an example of adjusting a phase difference between an item A and an item B based on the “phase adjusting information”. In this example, the phase of a trend of the item B is delayed by a predetermined time (20 minutes) so that the trend comes close to a trend of the item A. In this manner, the trend of the item B is made approximate to the trend of the item A. In FIG. 11, the trend of the item B before the phase adjustment is shown by a dotted line 54, the trend of the item B after the phase adjustment by a solid line 55, and the trend of the item A by a solid line 56. After the phase adjustment, it is possible to analyze, for example, the similarity in trend between the items A and B by, for example, applying the “MT computation” to the difference between the trend shown by the solid line 55 and the trend shown by the solid line 56.

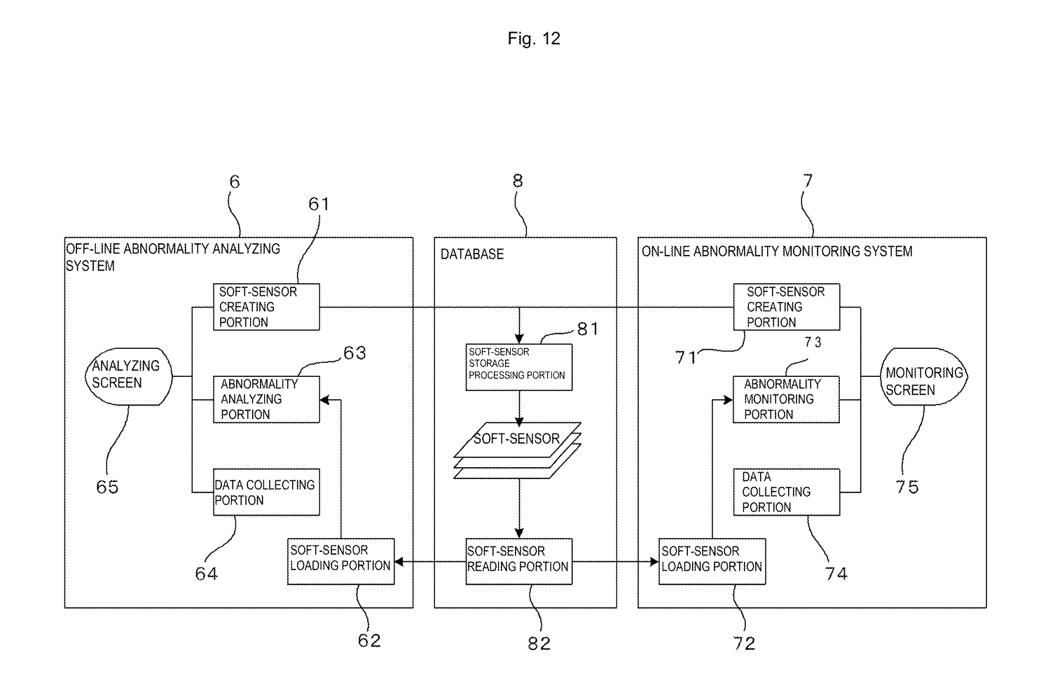

FIG. 12 is a block diagram illustrating a configuration of a plant analyzing system according to another embodiment of the present disclosure.

As illustrated in FIG. 12, the plant analyzing system includes an off-line abnormality analyzing system 6 for analyzing abnormality off-line, an on-line abnormality monitoring system 7 for monitoring abnormality on-line, and a database 8 for storing a soft-sensor.

As illustrated in FIG. 12, the off-line abnormality analyzing system 6 includes a soft-sensor creating portion 61, a soft-sensor loading portion 62, an abnormality analyzing portion 63, a data collecting portion 64, and an analyzing screen 65. The soft-sensor creating portion 61 accepts to create a soft-sensor using the off-line abnormality analyzing system 6. The soft-sensor loading portion 62 loads the soft-sensor from the database 8. The abnormality analyzing portion 63 performs off-line analysis using the soft-sensor loaded in the soft-sensor loading portion 62. The data collecting portion 64 collects data of a plant. The analyzing screen 65 provides information such as an abnormality analysis result and an abnormality monitoring result to the user of the off-line abnormality analyzing system 6.

The on-line abnormality monitoring system 7 includes a soft-sensor creating portion 71, a soft-sensor loading portion 72, an abnormality monitoring portion 73, a data collecting portion 74, and a monitoring screen 75. The soft-sensor creating portion 71 accepts to create a soft-sensor using the on-line abnormality monitoring system 7. The soft-sensor loading portion 72 loads the soft-sensor from the database 8. The abnormality monitoring portion 73 performs on-line monitoring using the soft-sensor loaded in the soft-sensor loading portion 72. The data collecting portion 74 collects data of the plant. The monitoring screen 75 provides information such as an abnormality analysis result and an abnormality monitoring result to the user of the on-line abnormality monitoring system 7.

The database 8 includes a soft-sensor storage processing portion 81 and a soft-sensor reading portion 82. The soft-sensor storage processing portion 81 performs processing for storing the soft-sensors created by the soft-sensor creating portion 61 and the soft-sensor creating portion 71. The soft-sensor reading portion 82 reads the soft-sensor stored by the soft-sensor storage processing portion 81 and provides the soft-sensor to the off-line abnormality analyzing system 6 and the on-line abnormality monitoring system 7.

The off-line abnormality analyzing system 6 and the on-line abnormality monitoring system 7 can create, for example, know-how about production work as a soft-sensor. Then, the created soft-sensor can be stored in the database 8. For example, the operation staff and/or operator manipulate the off-line abnormality analyzing system 6 and the on-line abnormality monitoring system 7 to create, as a soft-sensor, definition of information handled by the operation staff and/or operator such as the definition about process data and/or processing data used for analysis or monitoring. The created soft-sensor is stored in the database 8 by the soft-sensor storage processing portion 81.

As illustrated in FIGS. 9A, 9B, and 10, the monitoring result or analysis result obtained by the soft-sensor created through the manipulation of the operation staff or operator is not a mere list of process data. These results can be displayed as tag data which are put together for each facility such as a pump, or for each procedure. The method of putting data together is information indicating the user's viewpoint. The method of putting data together also can be handled as soft-sensor information. In this manner, the method of putting data together can be created and stored as the know-how information about the production work.

When there is phase shifting between items as illustrated in FIG. 11, analysis and monitoring can be performed after adjusting the phases of trends of the items. Such phase adjusting information also can be handled as the soft-sensor information (preprocessing information). As a result, the above information can be created and stored as the know-how information about the production work.

Next, the cooperation between the productivity maintaining work and the productivity improving work using the soft-sensor will be described.

The soft-sensor output from one of the off-line abnormality analyzing system 6 and the on-line abnormality monitoring system 7 is loaded in the other system, whereby the cooperation between the productivity maintaining work and the productivity improving work can be realized. More specifically, the soft-sensor output from one of the off-line abnormality analyzing system 6 and the on-line abnormality monitoring system 7 may be directly loaded in the other system. Alternatively, the other system may load the soft-sensor temporarily stored in the database 8.

Examples of modes of the cooperation will be described below.

First, a cause of the problem that has occurred in the past is analyzed in the productivity improving work. Countermeasure processing and/or detection processing resulting from the analysis can be promptly reflected in the productivity maintaining work. The procedures to be taken in this case will be described below.

(1) In the event of abnormality in the productivity improving work, to investigate a cause thereof, the productivity improving staff such as operation staff or maintenance staff manipulates the data collecting portion 64 of the off-line abnormality analyzing system 6 to collect information (history data), to be used for the investigation, from a plurality of data sources.

(2) The productivity improving staff manipulates the abnormality analyzing portion 63 of the off-line abnormality analyzing system 6 to analyze the abnormality based on the collected information.

(3) Upon finding the cause of the abnormality, the productivity improving staff manipulates the soft-sensor creating portion 61 of the off-line abnormality analyzing system 6 to create a soft-sensor from the processing for detecting the cause of the abnormality. This soft-sensor is created as the one that can be used for real-time detection by the on-line abnormality monitoring system 7. The created soft-sensor is stored in the database 8 by the soft-sensor storage processing portion 81.

(4) The productivity maintaining staff such as the operator is notified that the productivity improving staff has detected the cause of the problem and created the soft-sensor from the detection processing. The productivity maintaining staff manipulates the monitoring screen 75 of the on-line abnormality monitoring system 7, which causes the soft-sensor loading portion 72 to load the soft-sensor created by the off-line abnormality analyzing system 6.

In this case,

(a) Once the soft-sensor is loaded, the tag data used in the off-line abnormality analyzing system 6 is automatically defined.

(b) In addition, the on-line abnormality monitoring system 7 can redefine the tag data that has been automatically defined.

(5) The abnormality monitoring portion 73 of the on-line abnormality monitoring system 7 uses the loaded soft-sensor for monitoring abnormality. The abnormality monitoring portion 73 can then monitor in real time whether the problem that had previously occurred in the on-line abnormality monitoring system 7 has occurred again.

Next, the procedures in a second mode of the cooperation will be described. In this mode, in the event of a problem with the on-line abnormality monitoring system 7 in the productivity maintaining work, processing for diagnosing the problem (soft-sensor) is loaded in the off-line abnormality analyzing system 6. Furthermore, the off-line abnormality analyzing system 6 reproduces the problem by using past data and investigates the problem.

(1) In the productivity maintaining work, the productivity maintaining staff such as the operator uses the function of the data collecting portion 74 of the on-line abnormality monitoring system 7 for monitoring operation. More specifically, the data collecting portion 74 collects information to be used for the investigation from a plurality of data sources.

(2) The productivity maintaining staff manipulates the abnormality monitoring portion 73 to perform on-line abnormality monitoring based on the collected information, and check whether a problem has occurred. In the event of a problem, the productivity maintaining staff reports to the production chief about that. After confirming the problem, the production chief requests the productivity improving staff to investigate a cause thereof. The productivity improving staff requests the productivity maintaining staff to provide the time at which the problem has occurred, and processing for creating key information (KPI) from the procedures of monitoring processing with which the problem has been detected.

(3) Upon the request, the productivity maintaining staff manipulates the soft-sensor creating portion 71 of the on-line abnormality monitoring system 7 to create a soft-sensor from the procedures of monitoring processing with which the problem has been detected. This soft-sensor is created for use in creating a reproducing condition in the off-line abnormality analyzing system 6. The created soft-sensor is stored in the database 8.

(4) The productivity improving staff manipulates the analyzing screen 65 of the off-line abnormality analyzing system 6, which causes the soft-sensor loading portion 62 to load the soft-sensor created by the on-line abnormality monitoring system 7.

(a) Once the soft-sensor is loaded, the tag data used in the on-line abnormality monitoring system 7 is automatically defined.

(b) In addition, the off-line abnormality analyzing system 6 can redefine the tag data that has been automatically defined.

(5) The productivity improving staff confirms the processing of the loaded soft-sensor using the function of creating the KPI. Next, the productivity improving staff manipulates the data collecting portion 64 to obtain the past data of the time at which the problem has occurred. Furthermore, the abnormality analyzing portion 63 investigates whether the problem can be reproduced. When the reproduction is possible, the abnormality analyzing portion 63 analyzes the abnormality to find the cause thereof.

In this manner, the cooperation between the productivity maintaining work and the productivity improving work is realized through the sharing of the soft-sensor between the off-line abnormality analysis and the on-line abnormality monitoring.

Next, an example of using the soft-sensor for the sharing of operating skills and/or operation information will be described.

Usually in the production scene, experienced staff such as a veteran operator individually has their own operation know-how. Therefore, after a certain experienced staff member is retired, a similar operation to the one that had been enabled thanks to that staff member may no longer be performed by the remaining staff.

To avoid this inconvenience, a logic of the work done by the experienced staff in the plant operation can be shared by creating a soft-sensor from the logic with the on-line abnormality monitoring system 7 and storing the created soft-sensor in the database 8. In the plant operation, the on-line abnormality monitoring system 7 loads this soft-sensor from the database 8 to enable operation and/or analysis in accordance with a similar work logic to the work logic of the experienced staff. As a result, even after the experienced staff is retired, a similar operation and analysis to those that had been enabled by that staff can be still performed by using the soft-sensor.

New staff can refer to the soft-sensor of the operating method and/or analyzing method of the experienced staff stored in the database 8. This makes it possible to reproduce data processing, and/or operation and/or analysis using process data, which correspond to a good operation and analysis.

The constituent elements of the plant analyzing system according to the present embodiment can be mounted in arbitrary portions of the field control system.

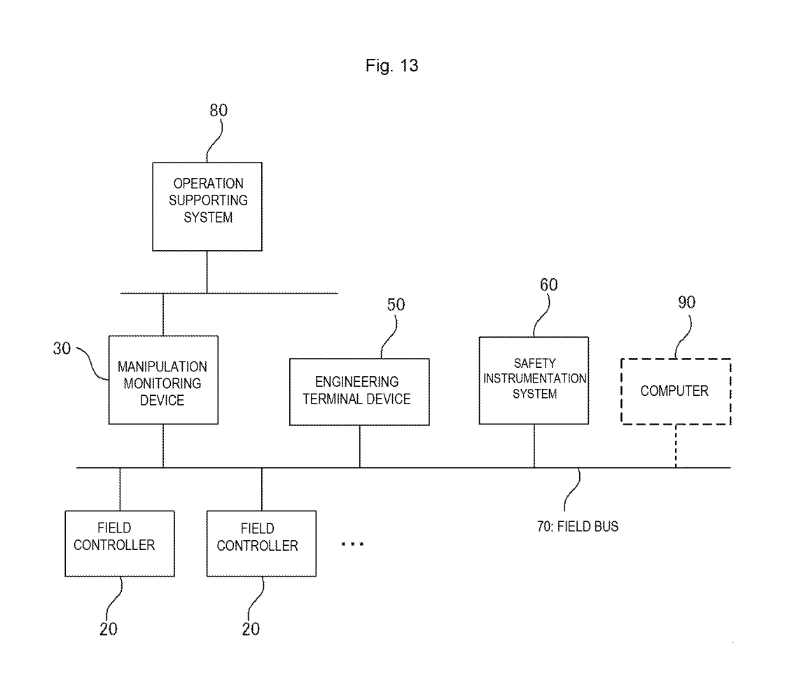

FIG. 13 is a block diagram illustrating an exemplary configuration of a distributed field control system.

As illustrated in FIG. 13, field controllers 20, 20, . . . are arranged in a plant in a distributed manner. The field controllers 20, 20, . . . are connected to a manipulation monitoring device 30 via a field bus 70. With this configuration, an operator using the manipulation monitoring device 30 can manipulate and monitor the entire plant through the field controllers 20, 20, . . . .

The field bus 70 is also connected to an engineering terminal device 50 for performing a maintenance work and the like of the plant, and to a device management system (safety instrumentation system) 60 for managing maintenance information and the like of field devices arranged in the plant.

Furthermore, an operation supporting system 80 is arranged as a host system of the manipulation monitoring device 30. The operation supporting system 80 supports the plant operation by performing, for example, advanced control, data accumulation, and data analysis.

When the plant analyzing system according to the present embodiment is constructed in the field control system having the above configuration, constituent elements corresponding to the off-line abnormality analyzing system 6 and the database 8, for example, can be arranged in the operation supporting system 80 or the manipulation monitoring device 30.

In addition, a constituent element corresponding to the on-line abnormality monitoring system 7 can be arranged in the manipulation monitoring device 30 or the field controller 20. When the constituent element corresponding to the on-line abnormality monitoring system 7 is mounted in the manipulation monitoring device 30, it is not necessary for the field controllers 20, 20, . . . to perform computation processing for monitoring. This eliminates the load of the computation processing, which would otherwise be imposed on the field controllers 20, 20, . . . . The manipulation monitoring device 30 can monitor in an integrated manner a result of abnormality detection processing created in the productivity improving work by mounting, in the field controller 20, the constituent element such as an abnormality detection logic corresponding to the on-line abnormality monitoring system 7, and by the manipulation monitoring device 30 collecting, through the field bus 70, computation results obtained by the on-line abnormality monitoring in the field controller 20.

A computer 90 (FIG. 13) on which the constituent element corresponding to the on-line abnormality monitoring system 7 is mounted may further be connected to the field bus 70. In this case, the computation result executed by the computer 90 may be written in the field controllers 20, 20, . . . through the field bus 70. The manipulation monitoring device 30 collects the computation results written in the field controllers 20, 20, . . . through the field bus 70, whereby a working condition can be obtained similarly to the case where the field controller 20 performs the on-line abnormality monitoring. In this case, the computation processing required for the field controllers 20, 20, . . . is light. Therefore, the load of the computation processing imposed on the field controllers 20, 20, . . . can be significantly reduced.

The applicable range of the present disclosure is not limited to the embodiments described above. The present disclosure can widely be applied to the plant analyzing system for analyzing a state of a plant based on data obtained from the plant.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A plant analyzing system for analyzing a state of a plant based on data obtained from the plant, comprising:
an accepting section that accepts a definition of a soft-sensor for creating key information used for diagnosing the plant based on the data obtained from the plant;
a storage section that stores the soft-sensor defined through the accepting section;
a monitoring data generating section that generates the key information in real time as data for monitoring the plant based on the data obtained from the plant and using the soft-sensor stored in the storage section;
a monitoring data display section that displays in real time the data for monitoring the plant, generated by the monitoring data generating section, on a screen for monitoring an operation;
a history data accumulating section that accumulates the data obtained from the plant as history data; and
an analyzing data generating section that generates the key information, as data for analyzing a plant state of the past, based on the history data accumulated in the history data accumulating section by using the soft-sensor stored in the storage section.

2. The plant analyzing system according to claim 1, further comprising:
a logic display section that displays, on the screen for monitoring an operation, a content of the soft-sensor stored in the storage section.

3. The plant analyzing system according to claim 1, wherein the soft-sensor includes pattern recognition using a Mahalanobis-Taguchi method.

4. The plant analyzing system according to claim 1, wherein the soft-sensor includes frequency separating processing.

5. The plant analyzing system according to claim 1, wherein the accepting section accepts the definition of the soft-sensor through the screen for monitoring an operation.

6. The plant analyzing system according to claim 1, wherein the soft-sensor includes information specifying a method of displaying the data for monitoring the plant using the monitoring data display section.

7. The plant-analyzing system according to claim 1, further comprising:
an analyzing data display section that displays the analyzing data generated by the analyzing data generating section,
wherein the soft-sensor includes information specifying a method of displaying the analyzing data using the analyzing data display section.

8. The plant analyzing system according to claim 6, wherein the information specifying a display method specifies a method of assembling data to be displayed.

9. The plant analyzing system according to claim 7, wherein the information specifying a display method specifies a method of assembling data to be displayed.
